(19) United States
(12) Patent Application Publication
(10) Pub. No.: US 2020/0143461 A1
(43) Pub. Date: May 7, 2020

(54) CUSTOM, TRANSACTION-BASED USER INTERACTIONS WITH EXTERNAL SYSTEMS

(71) Applicant: MOXTRA, INC., CUPERTINO, CA (US)

(72) Inventors: HE HUANG, SAN JOSE, CA (US); SUBRAH S. IYAR, LOS GATOS, CA (US)

(21) Appl. No.: 16/179,930

(22) Filed: Nov. 3, 2018

(51) Int. Cl. G06Q 40/02; G06Q 20/32; H04L 29/08

(52) U.S. Cl. CPC G06Q 40/02; H04L 67/22; G06Q 20/3223

(57) ABSTRACT

An application service that provides for custom, transaction-based interactions between users of an application and transactional systems external to that application and for creating a record of those interactions. Users participate in online transactions by responding to requests from external systems in real-time and from within the application. Singular, customized user interfaces, such as icons, are generated in real time for the particular transactional system's requests and the corresponding user's responses during the performance of a transaction. Records of the transactional requests and user responses are created so that transactions may be audited.

### FIELD OF THE DISCLOSURE

The disclosure relates to electronic transactions, and more specifically to conducting and recording custom, transaction-based interactions between an application's users and external systems.

### BACKGROUND

Transactions occur in everyday life, for example, when you exchange money for goods and services. Transactions are an exchange, usually a request and response, that occurs as a routine event in running the day-to-day operations of an organization. Online transactions, particularly online, business-to-business transactions, have grown at a phenomenal rate. Indeed, a recent Forrester Research Inc. report projected that online, business-to-business transactions will grow from $7.88 trillion in 2017 to $8.96 trillion in sales in 2018. These transactions are performed on suppliers' e-commerce sites, business networks, product procurement systems, services procurement systems, employee apps for purchasing travel and entertainment services, and EDI. Electronic Data Interchange, which is a major component of these transactions, is the computer-to-computer exchange of business documents in a standard electronic format between business partners.

Another major trend in business is collaborative work management using online collaboration and sophisticated workflows across enterprises, organizations, project teams and even ad hoc teams. Increasingly, workflows span multiple, heterogenous businesses. Project team members may be employees or agents of different organizations with disparate computing systems. Collaborative work management is growing alongside, and often in tandem with, online, business-to-business transactions. These transactions are key components in collaborative workflows. Mission-critical business applications often depend upon the ease, efficiency and integrity of online transactions between the application and an external, transactional system. The transactional ease, efficiency and integrity would be improved if application users could conduct business with external systems from within their application.

What is needed therefore are custom, transaction-based user interactions with external systems.

### SUMMARY

Technology is disclosed for an application service that provides for custom, transaction-based interactions between users of an application and transactional systems external to that application and for creating a record of those interactions (the “technology”). The technology enables one or more users to participate in online transactions by responding to requests from external systems in real-time and from within the application. The technology facilitates user responses to external system requests by generating a singular user interface, such as an icon, customized in real time for the particular transactional system's request and the corresponding user's response during the performance of a transaction. The technology enables the creation of a record of the transactional requests and user responses. In that way, user responses during a transaction can be audited.

In various embodiments, the technology provides a request-response service that can be used in real-time by one or more users and one or more transactional systems. For example, in one embodiment, consider that an organization holds several accounts with a financial institution. An agent of the organization initiates a business process, which moves funds from one account to another, requires approval from four different managers of the organization. That agent, as a user in the organization's business application, initiates the process with the financial institution's transactional system. The four managers, as users in the application, will each receive requests for approvals from the transactional system. Without leaving their organization's business application, the managers are able to receive, and respond to requests, from the financial institution's transactional system.

In various embodiments, the technology provides a custom interface service that can be used to generate a singular user interface, such as an icon, that is customized in real time for the particular, transactional system's request and the corresponding user's response during the performance of a transaction. Consider again the above example of one embodiment, one of the four managers is working within the business application. On the screen of her device, a message window appears with two custom interfaces. The message window contains information re the transfer of funds. One customer interface is a green button with the text ‘approve’. The other customer interface is a red button with the text ‘decline’. That manager can choose to respond by clicking the green button or by clicking the red button.

In various embodiments, the technology provides a transaction record service that can be used to record data evidencing each interaction between an application's users and an external, transactional system during the performance of a transaction. Consider again the above example of one embodiment, the four managers are each presented with custom interfaces (green and red buttons) and each respond. A record will be kept of the transaction that will include pertinent information related to the requested funds transfer. The transaction record will include pertinent information related to each manager, such as what custom interfaces they were presented with and when, and what response they took and when.

### BRIEF DESCRIPTION OF THE DRAWINGS

The drawings described herein are for illustrative purposes only of selected embodiments and not all possible implementations and are not intended to limit the scope of the present disclosure.

FIG. 1 is a block diagram illustrating an environment in which the technology may operate in various embodiments.

FIG. 2 is a block diagram illustrating an environment for providing a transactional interaction service, a request-response service, a custom interface service and a transaction record service, consistent with various embodiments.

FIG. 3 is a series of exemplar screen shots from a device of a user of FIG. 2, which show the performance of transaction that includes an interaction between a transactional system and an application user, consistent with various embodiments.

FIG. 4 is a series of exemplar screen shots from a device of a user of FIG. 2, which show the performance of transaction that includes an interaction between a transactional system and an application user, consistent with various embodiments.

FIG. 5 is a block diagram that illustrates the data recorded from a transactional interaction between an application user and a transactional system, consistent with various embodiments.

FIG. 6 is a block diagram of a system for a transactional interaction service of FIG. 1, consistent with various embodiments.

FIG. 7 is a flow diagram of a process of conducting user interactions with transactional systems, consistent with various embodiments.

FIG. 8 is a flow diagram of a process of recording data related to user interactions with transactional systems, consistent with various embodiments.

FIG. 9 is a block diagram illustrating components of an apparatus that may perform various operations described by the technology.

### DEFINITIONS

Action Universal Resource Locator (Action URL): a locator that identifies a resource by its location on a computer network and a method of retrieving it that, in some embodiments, may be used to store and retrieve a transactional request.

Cascading Style Sheets (CSS): a descriptor indicating how an individual element of a HyperText Markup Language (HTML) document or webpage (an HTML element) should be displayed.

Custom Interface: a singular user interface, such as an icon, that is customized in real time for the particular, transactional system's request and the corresponding user's response during the performance of a transaction. E.g., a button that, when clicked by a user, allows a user to take a specific action, such as approve a deposit to a financial account.

Interaction Metadata: data that describes and provides information about a transactional interaction.

Interaction Record: an electronic record which contains interaction metadata.

Payload: data transmitted over a network that is stripped of any header information or other descriptive metadata and which represents the data intended to be sent by the transmitter. E.g., payload may be the substance of a request sent by the transactional system or the substance of a response sent by a user.

Response Universal Resource Locator (Response URL): a locator that identifies a resource by its location on a computer network and a method of retrieving it that, in some embodiments, may be used to store and retrieve a user response to a transactional request.

Transaction Metadata: data that describes and provides information about a transaction.

Transaction Record: an electronic record which contains transaction metadata.

Transactional Interaction: an interaction between a transactional system and an application's user consisting of a transactional request and a user response, which are part of the performance of a transaction. The performance of a transaction may involve more than one transactional interaction.

Transactional Request: a request from a transactional system for a response from an application's user as part of the performance of a transaction. E.g., a banking system may request a user's approval of a deposit to a bank account. A transactional request may be initiated by a user of the transactional system. E.g., an officer of a bank may be a user of a banking system.

Transactional System: a computing system that, in whole or in part, performs transactions, such as, withdrawal from bank accounts, approval of contracts and purchase of goods and services, and that is external to an application.

User Response: a response from an application's user to a request from a transactional system as part of the performance of a transaction. E.g., at the request of a banking system, a user may decline to sign a document authorizing payment of fees.

### DETAILED DESCRIPTION

### Environment for Application Service

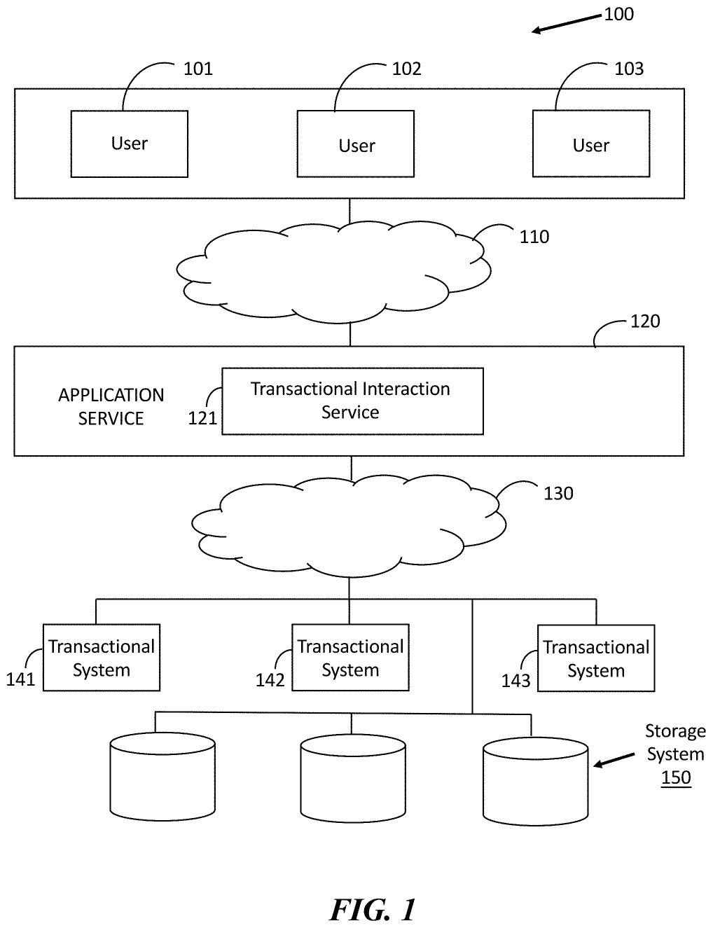

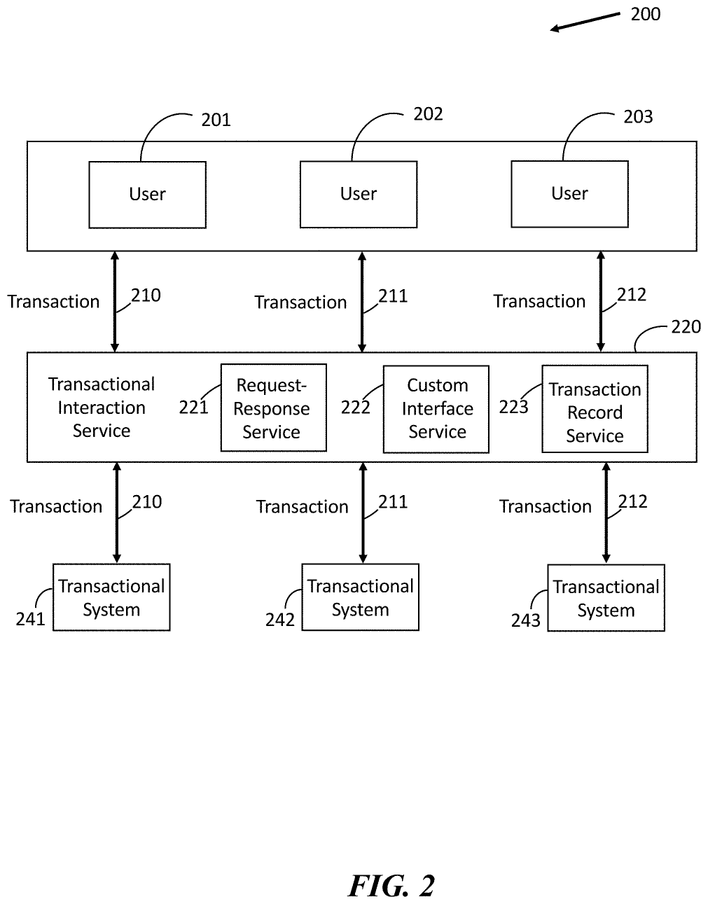

Technology is disclosed for an application service that provides for custom, transaction-based interactions between users of an application and systems external to that application and for creating a record of those interactions (the “technology”). Several embodiments of the technology are described in more detail in reference to the figures. Turning to FIG. 1, FIG. 1 is a block diagram illustrating an environment 100 in which the technology may operate in various embodiments. The environment 100 includes an application service 120 that provides services, including services such as a transactional interaction service 121, to a set of users, e.g., user 101, user 102 and user 103, and to a set of transactional systems, e.g., transactional system 141, transactional system 142 and transactional system 143. Further details regarding transactional interactions and creating records of those interactions are described with reference to at least FIGS. 2 and 6-9.

The set of users may access the application service 120 via communication networks, such as communication network 110, using a variety of devices, including a desktop, a laptop, a tablet PC, a smart phone, or a telephone. The set of transactional systems may access the application service 120 via communication networks, such as communication network 130. In various embodiments, application service 120, the set of users and the set of transactional systems may access storage systems, such as storage system 150 via communication networks, such as communication network 110 and communication network 130.

Application service 120 may be implemented in a variety of configurations. One typical configuration may include an online configuration in which application service 120 is implemented in a distributed network, for example, LAN, WAN or Internet. Users and transactional systems access application service 120 over communication networks such as network 110 and network 130 In various embodiments, application service 120 may also be implemented in a client-server configuration in which an application corresponding to the client portion may be installed on the device of the user. Users may access application service 120 using a web browser or an application service application installed on the device of the user.

### Transactional Interaction Service

Turning now to FIG. 2, FIG. 2 is a block diagram, consistent with various embodiments, illustrating an environment 200 for the application service of FIG. 1. Transactional interaction service 220 of environment 200 may be similar to transactional interaction service 120 of FIG. 1. Users 201, 202 and 203 of environment 200 may be similar to users 101, 102 and 103 of FIG. 1. Transactional systems 241, 242 and 243 of environment 200 may be similar to transactional systems 141, 142 and 143 of FIG. 1.

Transactional interaction service 220, consistent with various embodiments, enables transaction-based interactions between users, such as users 201, 202 and 203, and transactional systems, such as transactional systems 241, 242 and 243, that occur during the performance of transactions, such as transactions 210, 211 and 212. Transactions may be initiated by a user or a transactional system. A transactional system may initiate a transaction by an action taken by one of that system's users. During the performance of one transaction, a transactional system may request one or more responses from an application's user or users.

For example, an application service, such as application service 120 of FIG. 1, may provide online collaboration services to its users, who work for an organization that holds accounts with various financial institutions. A user may initiate a transaction that consists of an online deposit into an account at one of these financial institutions. During the performance of the deposit, the financial institution may require approval from four of the organization's employees. In other words, during the performance of the online transaction, the financial institution's transactional system may request responses from four of the application service's users. The transaction requires a series of four transactional requests and user responses. Transactional interaction service 220, thru request-response service 221, custom interface service 222 and transaction record service 223, enables the four transaction-based interactions required to complete the deposit.

Request-response service 221, consistent with various embodiments, receives transactional requests from transactional systems, such as transactional systems 241, 242 and 243, during the performance of transactions, such as transactions 210, 211 and 212. For example, a transactional request may contain data re the transactional system, the action and/or information requested to be taken and/or provided by the user, the initiator, the timestamp, and the attributes for a custom interface that is specially created for this specific transactional request. A transactional system may include systems such as a financial technology system (e.g., a banking system or a brokerage system), a system for purchasing goods and/or services, a system for transporting purchased goods, systems for making insurance claims, and systems of other entities with which an organization conducts business. Actions requested to be taken may include actions such as approve, reject, sign, decline, attach, review and call. The initiator may identify the system or user who initiated the requesting transaction. The timestamp may identify the time the related transaction was initiated, and/or the transactional request was sent, consistent with various embodiments.

In some embodiments, a transactional request may contain an action URL and/or a response URL. An action URL is a universal resource locator that identifies a resource by its location on a computer network and a method of retrieving it, which may be used to store and retrieve a transactional request. A response URL is a universal resource locator that identifies a resource by its location on a computer network and a method of retrieving it, which may be used to store and retrieve a user response.

The attributes for a custom interface contained in a transactional request, consistent with various embodiments, provide the information necessary to generate a customized user interface that will enable the specific transactional interaction required for the performance of a particular transaction. For example, in some embodiments, the custom interface attributes described in the following table may be included in a transactional request.

| Attribute | Description |
|---|---|
| id | unique identifier for custom interface |
| text | text to be displayed on custom interface |
| type | type of transactional interaction, such as approve, reject, |
| | sign and decline |
| value | value of custom interface for logical processing |
| act_URL | URL for transactional request payload |
| resp_URL | URL for user response payload |
| title | title text when a mouse hovers on custom interface |
| payload | HTTP body for transactional request |
| form | identifier of form to be used for custom interface, such as |
| | a button |
| title text | additional text to be displayed when mouse hovers on |
| | custom interface |
| ok_text | text, such as ‘ok’, which may be used after user interaction |
| | with interface |
| dismiss_text | text, such as ‘dismiss', which may be used after user |
| | interaction |
| color | color of custom interface in hex code |
| style | Cascading Style Sheet style or any custom style definition |
| | for interface |
| template | identifier, if any, of a preset format for custom interface |
| content | data format of the content, including media, for payload of |
| | user response |
| interacted | Boolean value (T\|F) indicating user interaction with custom |
| | nterface |
| length | size of the transactional request payload |

Turning back to FIG. 2, custom interface service 222, consistent with various embodiments, generates on a screen of a device of a user, such as users 201, 202 and 203, a custom interface, such as an icon, specially created in real time for the particular request from a transactional system, such as transactional systems 241, 242 and 243, and for the corresponding user's response during the performance of a transaction, such as transactions 210, 211 and 212. Custom interface service 222 uses the custom interface attributes contained in a transactional request, such as those shown in the above table, to generate a custom interface on the screen of a user's device. For example, custom interface service 222 may generate a green button with the text, ‘Approve’, on a user's device that, when clicked, indicates the user's response to a transactional system's request. The user approved a deposit into a financial institution's account. In this example, values for some of the custom interface attributes in the transactional request may have been the following: text=‘Approve’; type=‘approve_deposit’; title=‘Approve Deposit’; form=‘button’, and color=‘#008000’.

Request-response service 221, consistent with various embodiments, delivers user responses from users, such as users 201, 202 and 203, to transactional requests from transactional systems, such as transactional systems 241, 242 and 243, during the performance of transactions, such as transactions 210, 211 and 212. For example, a user response may contain data re the user, the action taken (and/or the information provided) by the user, and the timestamp. Data re the user may include identifiers, such as a user id, email address and IP address. Actions taken may include actions such as approved, rejected, signed, declined, attached, reviewed and called. The timestamp may identify the time the related transaction was initiated, the time the transactional request was sent, and/or the time the user responded, consistent with various embodiments. In some embodiments, a user response may be delivered to a response URL that was provided in the transactional request.

Transaction record service 223, consistent with various embodiments, creates an interaction record that provides evidence of each interaction (transactional request and user response) between an application's users, such as users 201, 202 and 203 and a transactional system, such as transactional systems 241, 242 and 243, during the performance of a transaction, such as transactions 210, 211 and 212. Transaction record service 223 includes the interaction records in the transaction record it creates for every transaction. The transaction record, consistent with various embodiments, provides the information necessary to audit a transaction between two independent entities by means of their corresponding, independent computing systems. For example, in some embodiments, the transaction record may include the information provided in the following table.

| | TRANSACTION RECORD |
|---|---|
| | Transaction ID: AXB-1P3-768 |
| | Transactional System: bankofzam |
| | System Users: jane@bankofzam.com |
| | Application Users: moxie@corp.com |
| | Initiator: jane@bankofzam.com |
| | Status: Completed |
| | Transaction Start Date: 5/12/2018 |
| | Transaction End Date: 5/14/2018 |
| | Documents Uploaded: 2 |
| | Documents Signed: 1 |
| | Document Names: |
| | AugustInvestmentFees.doc; |
| | AugustInvestmentFeesAuthorization.doc |
| | Transactional Interactions: AXB-1P3-768 |
| 1 | ID: 6HY-J7V-89H |
| | Label: Approve Payment |
| | Requested by: jane@bankofzam.com |
| | Response URL: https://bankofzam.com/approve |
| | Sent Timestamp: 5/12/2018 11:30:25 PM PT |
| | Timestamp Button Click: 5/12/2018 11:34:59 PM |
| | PT Clicked by: moxie@corp.com |
| | Response Received at: 5/12/2018 11:35:03 PM PT |
| | Document Title: AugustInvestmentFees.doc |
| 2 | ID: BFT-7HC-K42 |
| | Label: Decline Payment |
| | Requested by: jane@bankofzam.com |
| | Response URL: https://bankofzam.com/decline |
| | Sent Timestamp: 5/12/2018 11:31:41 PM PT |
| | Timestamp Button Click: |
| | Clicked by: |
| | Response Received at: |
| | Document Title: AugustInvestmentFees.doc |
| 3 | ID: LP0-NZ4-F32 |
| | Label: Sign |
| | Requested by: jane@bankofzam.com |
| | Response URL: https://bankofzam.com/sign |
| | Sent Timestamp: 5/12/2018 11:31:41 PM PT |
| | Timestamp Button Click: 5/12/2018 11:34:59 PM |
| | PT Clicked by: moxie@corp.com |
| | Response Received at: 5/12/2018 11:35:03 PM PT |
| | Document Title: AugustInvestmentFeesAuthorization.doc |
| 4 | ID: 765-FVT-T4B |
| | Label: Decline to Sign |
| | Requested by: jane@bankofzam.com |
| | Response URL: https://bankofzam.com/sign-decline |
| | Sent Timestamp: 5/12/2018 11:36:14 PM PT |
| | Timestamp Button Click: |
| | Clicked by: |
| | Response Received at: |
| | Document Title: AugustInvestmentFeesAuthorization.doc |

In the above example, a transaction (Transaction ID: AXB-1P3-768′) occurred between a corporation (‘corp’) and a bank (‘bankofzam’). The transaction was initiated by a user of the bank's transactional system (‘jane@bankofzam.com’) on May 12, 2018. During the performance of the transaction, the transactional system sent four transactional requests to a user of the corporation's application (‘moxie@corpc.com’) in sequence: 1 (‘Label: Approve Payment’); 2 (‘Label: Decline Payment;); 3 (‘Label: Sign’) and 4 (‘Label: Decline to Sign’). The application user did not respond to transactional requests 2 or 4. The application user did respond to transactional requests 1 and 3. The user responses were delivered to their respective response URLs, ‘https://bankofzam.com/approve’ and ‘https://bankofzam.com/sign’. The transaction ended on May 14, 2018. The above, exemplar transaction record provides the information necessary to audit a completed transaction between a corporation and a bank whereby an agent of a corporation approved a payment and signed a document at the request of an agent of a bank, consistent with various embodiments.

Transactional interaction service, such as transactional interaction service 220, request-response service, may be accessed using a variety of computing systems and a variety of devices, including a desktop computer, a laptop computer, a smartphone, or a tablet PC. It may also be accessed using a web browser installed on user devices. Further, the application service environment 200 is platform agnostic, that is, it may be accessed from computing systems and devices running on operating systems, such as The Open Group's UNIX®, IBM® z/OS®, Microsoft Corporation's Windows®, Apple Inc.'s rnacOS® and iOS®, Google Inc.'s Chrome OS™ operating systems, and various implementations of the Linux and Android OS operating systems.

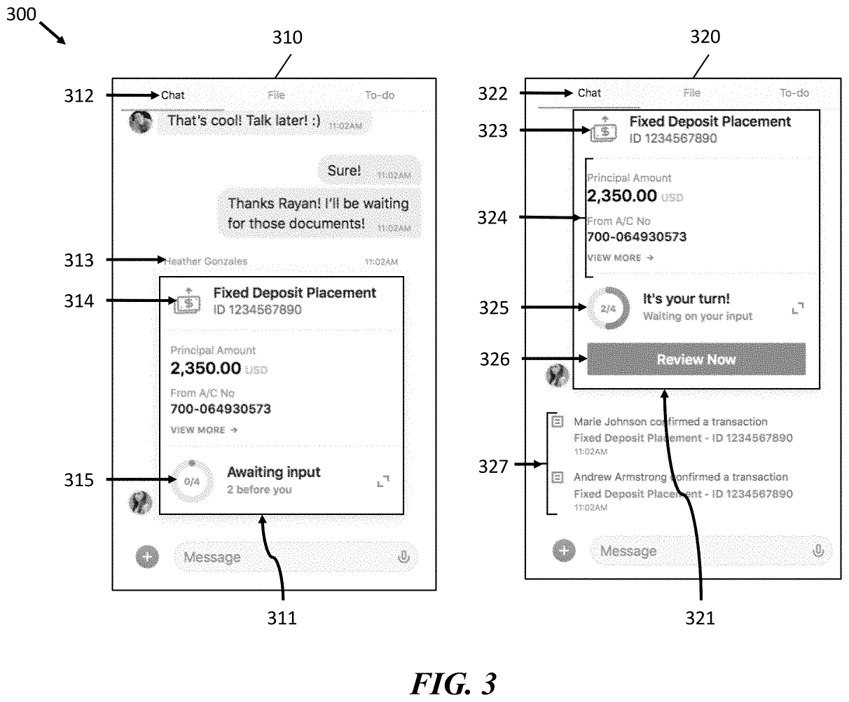

Turning now to FIG. 3, FIG. 3 is two exemplar screen shots 300 from a device of a user of FIG. 2 (the “present user”), consistent with various embodiments. Screen shot 310 shows a message thread occurring in chat function 312 of an application. Informational message 311 is being displayed with respect to transaction 314 (‘Fixed Deposit Placement’). User 313 (‘Heather Gonzales’) initiated transaction 314. Informational message 311 displays status 315 of transaction 314, which indicates that a transactional system is ‘Awaiting input’ and has received input from 0 of 4 users (‘0/4’). Status 315 also indicates that the present user is the third of four users who will be requested to provide input (‘2 before you’).

Screen shot 320 shows a message thread occurring in chat function 322 of an application. Informational message 321 is being displayed with respect to transaction 323 (‘Fixed Deposit Placement’). Informational message 321 displays pertinent information re transaction 323 at 324 (‘Principal Amount’ and ‘From A/C No’). Informational message 321 displays status 325 of transaction 323, which indicates that the transactional system has received responses from 2 of 4 users (‘2/4’). Status 325 also indicates that it is the present user's turn to provide input (‘It's your turn!’; ‘Waiting on your input’). The message thread occurring in chat function 322 includes informational messages 327 which indicate that both user (‘Marie Johnson’) and user (‘Andrew Armstrong’) responded to a transactional request by confirming the subject transaction (‘ID 1123457890’).

The present user is also being presented with custom interface 326 within the context of informational message 321. Custom interface 326 represents a transactional request from the transactional system to the present user. Custom interface 326 was specially created in real time for this specific request based on the custom interface attributes contained within the transactional request. In this example, the custom interface attributes resulted in the generation of a rectangular icon with the text ‘Review Now’, which—in response—the present user may choose to click or may choose not to click.

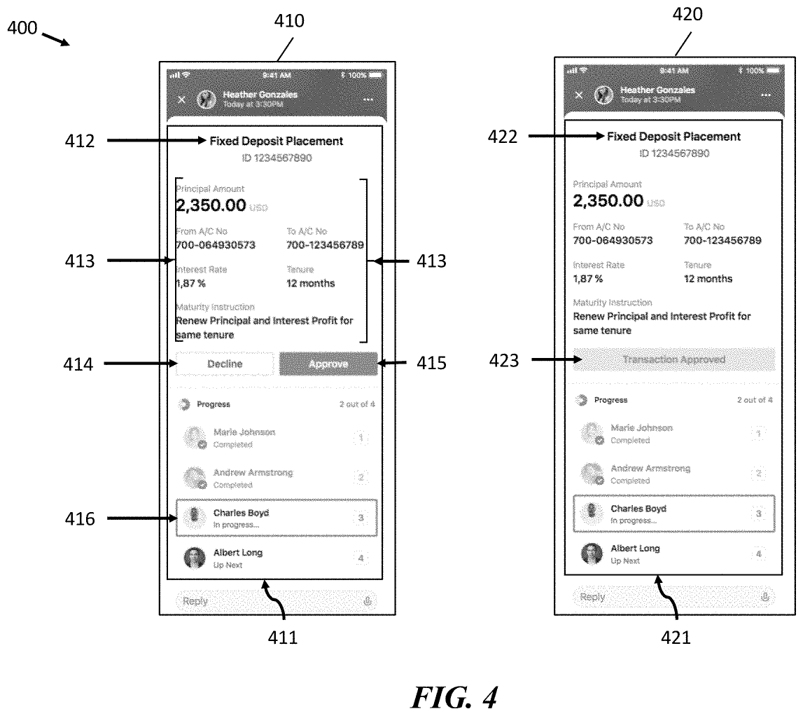

Turning now to FIG. 4, FIG. 4 is two exemplar screen shots 400 from the device of the user of FIG. 3, consistent with various embodiments. Screen shot 410 shows an informational message 411 being displayed with respect to transaction 412 (‘Fixed Deposit Placement’) after the present user clicked custom interface 326 (‘Review Now’) of FIG. 3. Informational message 411 displays information relevant to reviewing a financial transaction, such as transaction 412, at 413 (‘Principal Amount’, ‘From A/C No’, ‘To A/C No’, ‘Interest Rate’, ‘Tenure’ and ‘Maturity Instruction’). Informational message 411 displays status 416 of transaction 412, which indicates that the present user's (‘Charles Boyd’) participation in transaction 412 is ‘in progress’.

The present user is also being presented with custom interfaces 414 and 415 within the context of informational message 411. Custom interface 414 represents a transactional request from the transactional system to the present user. Custom interface 414 was specially created in real time for this specific request based on the custom interface attributes contained within its corresponding transactional request. In this example, the custom interface attributes resulted in the generation of a rectangular icon with the text ‘Decline’, which—in response—the present user may choose to click or may choose not to click. Custom interface 415 represents a transactional request from the transactional system to the present user. Custom interface 415 was specially created in real time for this specific request based on the custom interface attributes contained within its corresponding transactional request. In this example, the custom interface attributes resulted in the generation of a rectangular icon with the text ‘Approve’, which—in response—the present user may choose to click or may choose not to click.

Turning back to FIG. 4, screen shot 420 shows an informational message 421 being displayed with respect to transaction 422 (‘Fixed Deposit Placement’) after the present user clicked custom interface 415 (‘Approve’). Informational message 421 displays status 423 of transaction 422, which indicates that the present user approved the transaction (‘Transaction Approved’).

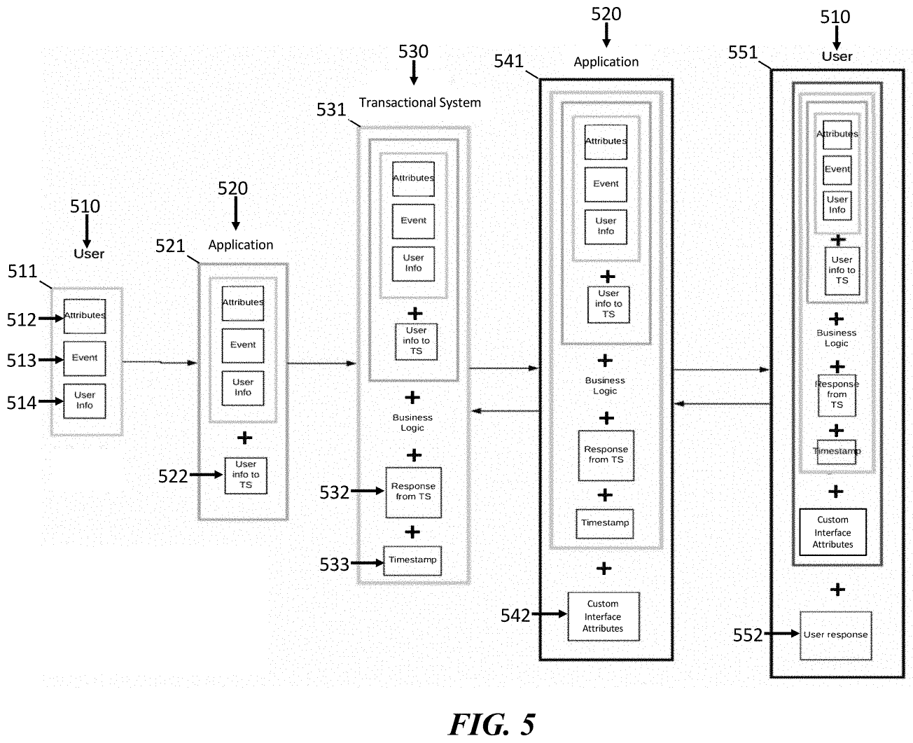

Turning now to FIG. 5, FIG. 5 is block diagram that illustrates data recorded during the course of a transactional interaction between a user of FIG. 2 and a transactional system of FIG. 2, consistent with various embodiments. The interaction record will become part of a transaction record created for a transaction of FIG. 2. User 510 initiated an event within application 520 that required a transaction with transactional system 530. As a result, at 511, data associated with the event, such as user info 514, the initiated event 513, and event attributes 512, were stored in a newly-created, transaction record (the “present record”).

Application 520 initiated the transaction with transactional system 530 by, among other things, sending data, such as user info to TS 522, to the transactional system 530. As a result, at 521, user info to TS 522 was added to the present record. Transactional system 530 received the data, processed that data with its own encoded business logic and sent data, such as response from TS 532, to application 520. As a result, at 531, response from TS 532 and timestamp 533 were added to the present record, consistent with various embodiments.

Subsequently, transactional system 530 sent a transactional request, which included custom interface attributes 542, to application 520. As a result, at 541, custom interface attributes 542 was added to the present record. Application 520 generated a custom interface corresponding to custom interface attributes 542 on the device of user 510. User 510 responded to the transactional request by means of the custom interface. As a result, at 551, user response 552 was added to the present record, consistent with various embodiments.

Similar additions will be made to the present record, consistent with various embodiments, when further transactional interactions are required and until the performance of the transaction is concluded.

### Example System for Application Service

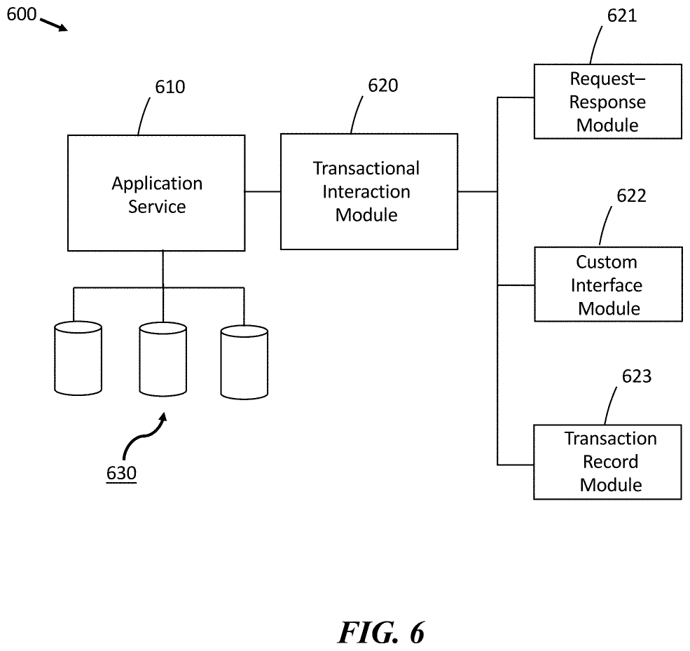

Turning now to FIG. 6, FIG. 6 is a block diagram of a system for an application service of FIG. 1, consistent with various embodiments.

In various embodiments, system 600 is implemented to perform functions such as the functions of environment 100. In various embodiments, application service 610 may be similar to the application service 120 of FIG. 1. Application service 610 includes various modules that provide services including transactional interaction services, request-response services, custom interface services and transaction record services.

Application service 610 includes transactional interaction module 620, request-response module 621, custom interface module 622 and transaction record module 623. In various embodiments, transactional interaction module 620 may be similar to transactional interaction service 220 of FIG. 2. Transactional interaction module 620 facilitates the conducting and recording of custom, transaction-based interactions between an application's users and transactional systems. Request-response module 621 may be similar to request-response service 221 of FIG. 2. Request-response module 621 facilitates the receipt of transactional requests from transactional systems and the delivery of responses to those requests from application users. Custom interface module 622 may be similar to custom interface service 222 of FIG. 2. Custom interface module 622 facilitates the generation of singular user interfaces, customized for specific transactional requests and corresponding user responses. Transaction record module 623 may be similar to transaction record module 223 of FIG. 2. Transaction record module 623 facilitates the creation of an interaction record for each transactional interaction during the performance of a transaction and of a transaction record for each transaction.

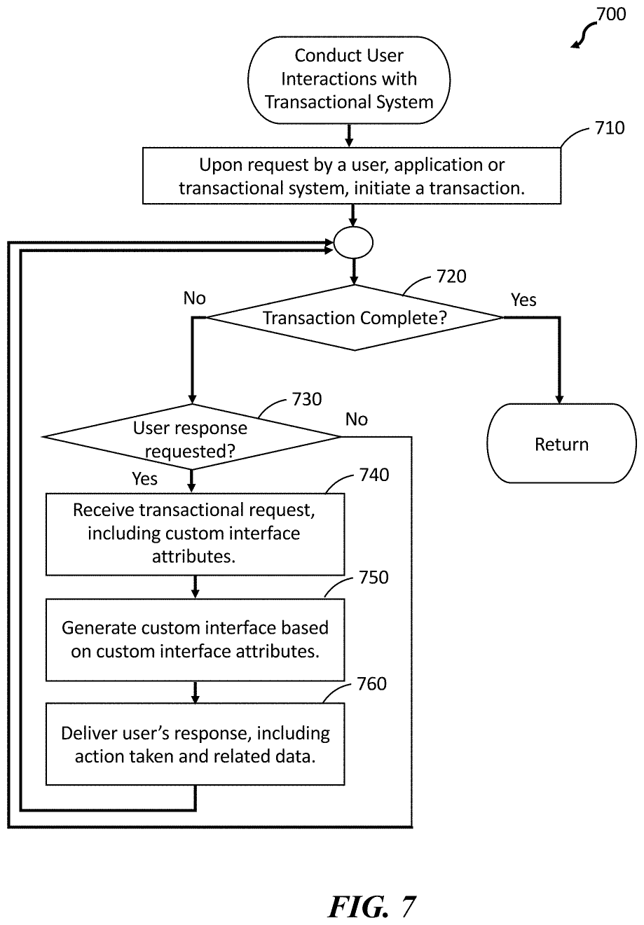

Turning now to FIG. 7, FIG. 7 is a flow diagram of a process of conducting user interactions with a transactional system, consistent with various embodiments.

In some embodiments, process 700 may be executed in a system such as system 600 of FIG. 6. At block 710, transaction interaction module 620 receives a request from a user, an application or a transactional system to initiate a transaction with a transactional system. At block 720, transaction interaction module 620 determines whether the transaction is complete. If not, at block 730, transaction interaction module 620 determines whether a user response has been requested by the transactional system. If not, transaction interaction module 620 returns to block 720. If so, at block 740, request-response module 621 receives the transactional request, including the custom interface attributes. In some embodiments, request-response module 621 retrieves the transactional request from an action URL. At block 750, custom interface module 622 generates a custom interface on the device of a user. At block 760, request-response module 621 delivers the user response, including action taken and related data, to the transactional system. In some embodiments, request-response module 621 delivers the user response to a response URL. Process 700 returns to block 720.

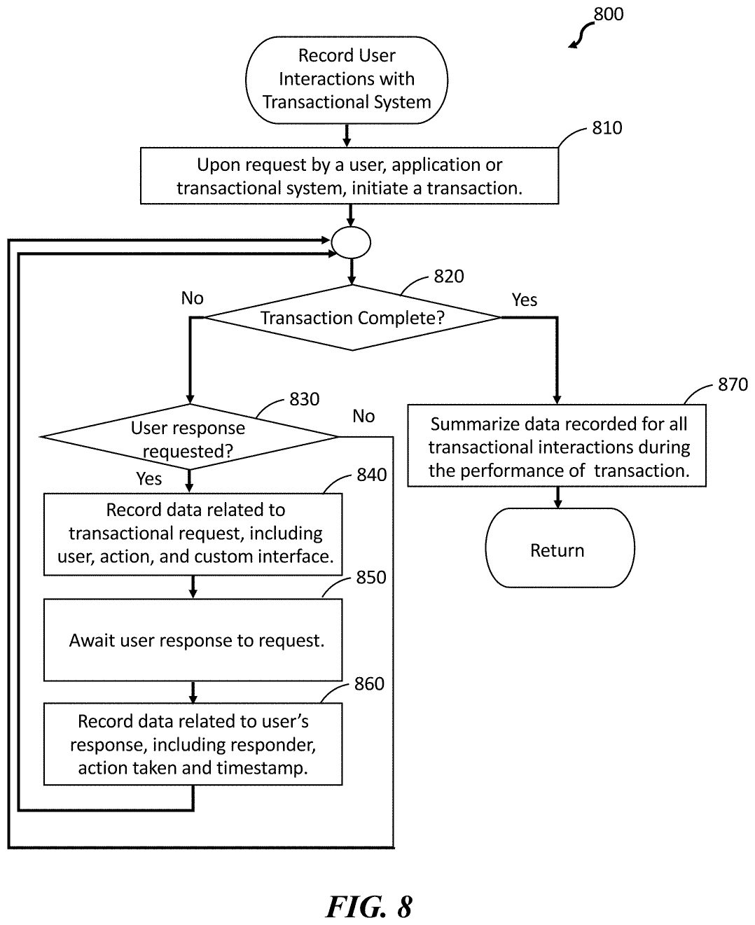

Turning now to FIG. 8, FIG. 8 is a flow diagram of a process of creating interaction records and a corresponding transaction record, consistent with various embodiments.

In some embodiments, process 800 may be executed in a system such as system 600 of FIG. 6. At block 810, transaction interaction module 620 receives a request from a user, an application or a transactional system to initiate a transaction with a transactional system. At block 820, transaction interaction module 620 determines whether the transaction is complete. If not, at block 830, transaction interaction module 620 determines whether a user response has been requested by the transactional system. If not, transaction interaction module 620 returns to block 820. If so, at block 840, transaction record module 623 records data related to the transactional request, including the user, the requested action and custom interface attributes, in a transaction record that corresponds to the transaction. At block 850, transaction record module 623 awaits the user's response to the transactional request. Upon the user's response, at block 860, transaction record module 623 records data related to the user response, including responder, action taken and timestamp, in the transaction record. Process 800 returns to block 820.

If the transaction is complete, at block 870, transaction record module 623 summarizes data it recorded for the transactional interactions during the performance of the transaction; and finalizes the transaction record.

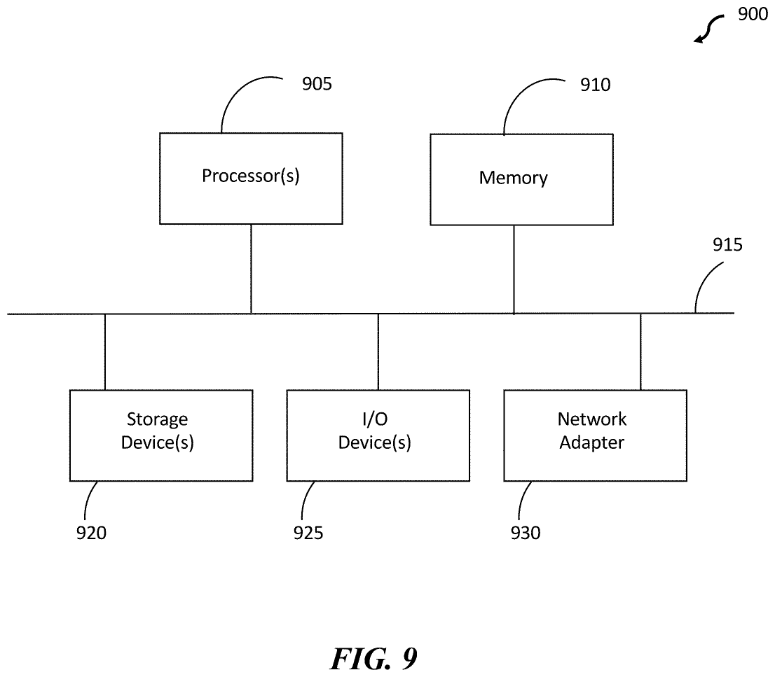

Turning now to FIG. 9, FIG. 9 is a block diagram illustrating components of an apparatus that may perform various operations described by the technology.

FIG. 9 is a block diagram of a computer system as may be used to implement features of some embodiments of the disclosed technology. Computing system 900 may include one or more central processing units (“processors”) 905, memory 910, input/output devices 925 (e.g., key-board and pointing devices, and display devices), storage devices 920 (e.g., disk drives), and network adapters 930 (e.g., network interfaces) that are connected to an interconnect 915. The interconnect 915 is illustrated as an abstraction that represents any one or more separate physical buses, point to point connections, or both connected by appropriate bridges, adapters, or controllers. The interconnect 915, therefore, may include, for example, a system bus, a Peripheral Component Interconnect (PCI) bus or PCI-Express bus, a Hyper Transport or industry standard architecture (ISA) bus, a small computer system interface (SCSI) bus, a universal serial bus (USB), IIC (I2C) bus, or an Institute of Electrical and Electronics Engineers (IEEE) standard 1394 bus, also called “Firewire”.

The memory 910 and storage devices 920 are computer-readable storage media that may store instructions that implement at least portions of the described technology. In addition, the data structures and message structures may be stored or transmitted via a data transmission medium, such as a signal on a communications link. Various communications links may be used, such as the Internet, a local area network, a wide area network, or a point-to-point dial-up connection. Thus, computer-readable media may include computer-readable media (e.g., “non-transitory” media) and computer-readable transmission media. The instructions stored in memory 910 may be implemented as software and/or firmware to program the processor(s) 905 to carry out actions described above. In some embodiments, such software or firmware may be initially provided to the processing system 900 by downloading it from a remote system through the computing system 900 (e.g., via network adapter 930).

The technology introduced herein may be implemented by, for example, programmable circuitry (e.g., one or more microprocessors) programmed with software and/or firmware, or entirely in special-purpose hardwired (non-program-mable) circuitry, or in a combination of such forms. Special-purpose hardwired circuitry may be in the form of, for example, one or more ASICs, PLDs, FPGAs, etc.

### Remarks

The above description and drawings are illustrative and are not to be construed as limiting. Numerous specific details are described to provide a thorough understanding of the disclosure. However, in certain instances, well-known details are not described in order to avoid obscuring the description. Further, various modifications may be made without deviating from the scope of the invention. Accordingly, the invention is not limited except as by the appended claims.

Reference in this specification to “one embodiment” or “an embodiment” or “some embodiments” or “various embodiments” means that a particular feature, structure, or characteristic described in connection with the embodiment is included in at least one embodiment of the disclosure. The appearances of these phrases in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

The terms used in this specification generally have their ordinary meanings in the art, within the context of the disclosure, and in the specific context where each term is used. Certain terms that are used to describe the disclosure in this specification are used to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that the same thing may be said in more than one way. One will recognize that “memory” is one form of a “storage” and that the terms may on occasion be used interchangeably.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any term discussed herein is illustrative only and is not intended to further limit the scope and meaning of the disclosure or of any exemplified term. Likewise, the disclosure is not limited to various embodiments given in this specification.

Those skilled in the art will appreciate that the logic illustrated in each of the flow diagrams discussed above, may be altered in various ways. For example, the order of the logic may be rearranged, sub-steps may be performed in parallel, illustrated logic may be omitted, other logic may be included, etc.

Without intent to further limit the scope of the disclosure, examples of instruments, apparatus, methods and their related results according to the embodiments of the present disclosure are given above. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

Furthermore, in the specification, figures and claims, reference is made to particular features (including method steps) of the invention. It is to be understood that the disclosure of the invention includes all possible combinations of such particular features. For example, where a particular feature is disclosed in the context of a particular aspect or embodiment of the invention, or a particular claim, that feature may also be used, to the extent possible, in combination with and/or in the context of other particular aspects and embodiments of the invention.

Certain terminology and derivations thereof may be used in the following description for convenience in reference only and will not be limiting. For example, words such as “upward,” “downward,” “left,” and “right” would refer to directions in the drawings to which reference is made unless otherwise stated. Similarly, words such as “inward” and “outward” would refer to directions toward and away from, respectively, the geometric center of a device or area and designated parts thereof. References in the singular tense include the plural, and vice versa, unless otherwise noted.

The term “comprises” and grammatical equivalents thereof are used herein to mean that other components, ingredients, steps, among others, are optionally present. For example, an article “comprising” (or “which comprises”) components A, B and C may consist of (i.e., contain only) components A, B and C, or may contain not only components A, B, and C but also contain one or more other components.

Where reference is made herein to a method comprising two or more defined steps, the defined steps may be carried out in any order or simultaneously (except where the context excludes that possibility), and the method may include one or more other steps which are carried out before any of the defined steps, between two of the defined steps, or after all the defined steps (except where the context excludes that possibility).

The term “at least” followed by a number is used herein to denote the start of a range beginning with that number (which may be a range having an upper limit or no upper limit, depending on the variable being defined). For example, “at least 1” means 1 or more than 1. The term “at most” followed by a number (which may be a range having 1 or 0 as its lower limit, or a range having no lower limit, depending upon the variable being defined). For example, “at most 4” means 4 or less than 4, and “at most 40%” means 40% or less than 40%. When, in this specification, a range is given as “(a first number) to (a second number)” or “(a first number)—(a second number),” this means a range whose limit is the second number. For example, 25 to 100 mm means a range whose lower limit is 25 mm and upper limit is 100 mm.

Aspects of the disclosed invention may be embodied as a system, method or process, or computer program product. Accordingly, aspects of the disclosed invention may take the form of an entirely hardware embodiment, an entirely software embodiment (including firmware, resident software, micro-code, etc.) or an embodiment combining software and hardware aspects that may all generally be referred to herein as a “circuit,” “module,” “program,” “device,” or “system.” Furthermore, aspects of the disclosed invention may take the form of a computer program product embodied in one or more computer readable media having computer readable program code embodied thereon.

Any element in a claim that does not explicitly state “means for” performing a specified function, or “step for” performing a specific function is not to be interpreted as a “means” or “step” clause as specified in 35. U.S.C. § 112 ¶6. Specifically, the use of “step of” in the claims herein is not intended to invoke the provisions of U.S.C. § 112 ¶6.

We claim:

1. A transactional interaction method comprising:
conducting, by a transactional interaction service executing on a computer system, one or more transactional interactions for a transaction between one or more users and one or more transactional systems, including:
receiving, by the transactional interaction service, one or more transactional requests to the one or more users from the one or more transactional systems;
receiving, by the transactional interaction service, a plurality of attributes for one or more custom interfaces corresponding to the one or more transactional requests;
generating, by the transactional interaction service, the one or more custom interfaces corresponding to the one or more transactional requests for the one or more users; and
sending, by the transactional interaction service, one or more user responses associated with the one or more customs interfaces to the one or more transactional systems.

2. The method of claim 1 further comprising:
creating, by the transactional interaction service, an interaction record of interaction metadata associated with the one or more transactional interactions; and
creating, by the transactional interaction service, a transaction record of transaction metadata associated with the transaction.

3. The method of claim 1 wherein conducting the one or more transactional interactions includes:
initiating, upon a request by one of the one or more users or by one of the one or more transactional systems, a performance of the transaction;
IF the performance is complete THEN concluding the conducting of the one or more transactional interactions;
ELSE IF a new transactional request occurs THEN processing the new transactional request;
generating a new custom interface corresponding to the new transactional request;
processing a new user response associated with the new custom interface;
returning to determining whether the performance is complete;
ELSE returning to determining whether the performance is complete.

4. The method of claim 2 wherein conducting the one or more transactional interactions includes:
initiating, upon a request by one of the one or more users or by one of the one or more transactional systems, a performance of the transaction; and
initializing a transaction record;
IF the performance is complete THEN concluding the creation of new interaction records;
finalizing the transaction record;
concluding the conducting of the one or more transactional interactions;
ELSE IF a new transactional request occurs THEN awaiting a new user response associated with the new transactional request;
creating a new interaction record associated with the new transactional request and the new user response;
adding the new interaction record to the transaction record;
returning to determining whether the performance is complete;
ELSE returning to determining whether the performance is complete.

5. A transactional interaction system comprising:
a processor;
a conduct logic configured to conducting, by a transactional interaction service executing on a computer system, one or more transactional interactions for a transaction between one or more users and one or more transactional systems, including:
a receive logic configured to receiving, by the transactional interaction service, one or more transactional requests to the one or more users from the one or more transactional systems;
a receive logic configured to receiving, by the transactional interaction service, a plurality of attributes for one or more custom interfaces corresponding to the one or more transactional requests;
a generate logic configured to generating, by the transactional interaction service, the one or more custom interfaces corresponding to the one or more transactional requests for the one or more users; and
a send logic configured to sending, by the transactional interaction service, one or more user responses associated with the one or more customs interfaces to the one or more transactional systems.

6. The system of claim 5 further comprising:
a create logic configured to creating, by the transactional interaction service, an interaction record of interaction metadata associated with the one or more transactional interactions; and
a create logic configured to creating, by the transactional interaction service, a transaction record of transaction metadata associated with the transaction.

7. A non-transitory, computer-readable medium storing program instructions that, when
executed by a processor, cause the processor to perform the method of:
conducting, by a transactional interaction service executing on a computer system, one or more transactional interactions for a transaction between one or more users and one or more transactional systems, including:
receiving, by the transactional interaction service, one or more transactional requests to the one or more users from the one or more transactional systems;
receiving, by the transactional interaction service, a plurality of attributes for one or more custom interfaces corresponding to the one or more transactional requests;
generating, by the transactional interaction service, the one or more custom interfaces corresponding to the one or more transactional requests for the one or more users; and
sending, by the transactional interaction service, one or more user responses associated with the one or more customs interfaces to the one or more transactional systems.

8. The medium of claim 7 wherein the processor further performs the method of:
creating, by the transactional interaction service, an interaction record of interaction metadata associated with the one or more transactional interactions; and
creating, by the transactional interaction service, a transaction record of transaction metadata associated with the transaction.
